(19) United States
(12) Patent Application Publication
(10) Pub. No.: US 2023/0418478 A1
(43) Pub. Date: Dec. 28, 2023

(54) TWEAKABLE BLOCK CIPHER ENCRYPTION USING BUFFER IDENTIFIER AND MEMORY ADDRESS

(71) Applicant: NXP B.V., Eindhoven (NL)

(72) Inventors: Wilhelmus Petrus Adrianus Johannus Michiels, Reusel (NL); Jan Hoogerbrugge, Helmond (NL); Paul Kimelman, Alamo, CA (US)

(21) Appl. No.: 17/848,346

(22) Filed: Jun. 23, 2022

(51) Int. Cl. G06F 3/06

(52) U.S. Cl. CPC G06F 3/0623; G06F 3/0622; G06F 3/0656; G06F 3/0659; G06F 3/0631; G06F 3/0673

(57) ABSTRACT

Tweakable block cipher encryption is described using a buffer identifier and a memory address. A method includes receiving a data block from a buffer, the buffer having a buffer identifier, combining a memory address and the buffer identifier to generate a tweak, encrypting the data block using the tweak in a tweakable block cipher, and storing the encrypted data block in in a memory at a location corresponding to the memory address

### BACKGROUND

Electronics are shipped with programming, parameters, or other valuable information stored in memory. Attackers with access to a system and low-cost equipment, may use a basic understanding of the processes of a memory read or write operation to detect or infer the secrets stored in those memories. One type of attack is generally referred to as side channel leakage, which extracts data bits by detecting electromagnetic field emissions or power fluctuations. In many cases, these attacks may be conducted with access only to the system's electromagnetic field or power environment. Another type of attack is to query the memory to read out the encrypted data and then attempt to decrypt it. These attacks may be performed without altering the contents of the memory.

A particularly valuable type of information is the machine learning (ML) models that are used for inference in an artificial intelligence (AI) system, e.g., artificial neural networks. When such models are stored in external memory, then the external memory may be encrypted so that an attacker cannot steal the model by probing the external memory interface bus.

A block cipher is often used for disk encryption to encrypt blocks of data, one block at a time with a secret key before writing each block to the disk. A tweakable block cipher uses a tweak in addition to the key during the encryption. The tweak is often based on a disk block index, sector index, or memory address. The tweak causes the same plaintext to result in a different ciphertext at different memory addresses without changing the key. However, when the same plaintext is read from the same sector for different purposes, e.g., when the same data is reused, then the ciphertext is the same.

### SUMMARY

Embodiments of a method and a device are disclosed. Tweakable block cipher encryption is described using a buffer identifier and a memory address. In an embodiment, the method involves receiving a data block from a buffer, the buffer having a buffer identifier, combining a memory address and the buffer identifier to generate a tweak, encrypting the data block using the tweak in a tweakable block cipher, and storing the encrypted data block in in a memory at a location corresponding to the memory address.

In an embodiment, encrypting the data block comprises using a tweakable block cipher in electronic code book mode. In an embodiment, encrypting the data block comprises encrypting using a symmetric block cipher.

An embodiment includes allocating the buffer to the data block, and generating the buffer identifier when the buffer is allocated to the data block. An embodiment includes re-allocating the buffer to the data block, and generating a new buffer identifier when the buffer is re-allocated.

In an embodiment, generating a new buffer identifier comprises generating a new buffer identifier notwithstanding the memory address. An embodiment includes combining the memory address and the new buffer identifier to generate a new tweak, and encrypting the data block using the new tweak in a tweakable block cipher, wherein the frequency distribution of the encrypted data block with the first tweak is different from the frequency distribution of the encrypted data block with the new tweak.

In an embodiment, the buffer identifier is a 64-bit value. In an embodiment, the data block is comprised of activation data of a machine learning inference model. In an embodiment, the data block is part of activation data and the buffer is an activation buffer and wherein the activation data is passed from one layer of a machine learning system to another layer of the machine learning system through the activation buffer.

An embodiment includes generating a new buffer identifier for each inference run of the machine learning system. In an embodiment, generating a new buffer identifier comprises combining a fixed buffer identifier with a current increment of an inference counter that increments for each inference run of the machine learning system.

In an embodiment, the activation data is configured for a rectified linear unit activation function. In an embodiment, the memory is an external memory. In an embodiment, combining comprises concatenating a binary representation of the memory address with a binary representation of the buffer identifier. In an embodiment, combining comprises applying an exclusive OR operation to the memory address and the buffer identifier.

Some embodiments pertain to a tweakable block cipher includes a memory storing executable instructions configured to, when executed by processing circuitry of the tweakable block cipher, cause the processing circuitry to perform operations that involve receiving a data block from a buffer, the buffer having a buffer identifier, combining a memory address and the buffer identifier to generate a tweak, encrypting the data block using the tweak in a tweakable block cipher, and storing the encrypted data block in in a memory at a location corresponding to the memory address. In an embodiment combining comprises concatenating a binary representation of the memory address with a binary representation of the buffer identifier

Some embodiments pertain to a machine learning system that involves an addressable memory, a buffer, the buffer having a buffer identifier, a tweakable block cipher to receive a data block from the buffer, to combine a memory address to the addressable memory and the buffer identifier of the buffer to generate a tweak, and to encrypt the data block using the tweak, and a storage interface to store the encrypted data block in in the addressable memory at a location corresponding to the memory address. An embodiment includes a processor to execute layers of a neural network, the processor further allocating the buffer to the data block, generating the buffer identifier when the buffer is allocated to the data block, and providing the buffer identifier to the tweakable block cipher.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a block diagram of a device with a computing system and encrypted mass storage.

FIG. 2 depicts a block diagram of an artificial intelligence system with an encrypted knowledge base.

FIG. 3 depicts a block diagram of a data storage system using a tweakable encryption system.

FIG. 4 depicts a block diagram of a tweakable block cipher using an XOR-encrypt-XOR construct.

FIG. 5 depicts a diagram of an inference run through a machine learning system with activation buffers and weights buffers.

FIG. 6 depicts a diagram of a second inference run through the machine learning system with activation buffers and weights buffers.

FIG. 7 depicts of a third inference run through the machine learning system with activation buffers and weights buffers.

FIG. 8 depicts a process flow diagram of using a buffer identifier and a memory address together as tweak for memory encryption.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The frequency distribution of a ciphertext can be observed by an attacker and this information can be used to infer the frequency distribution of the corresponding plaintext. This may be prevented by using a tweakable block cipher that has a different tweak even when the memory location is the same. In some embodiments, a memory address and a buffer identifier are combined to generate the tweak. In some embodiments, the buffer identifier is associated with a buffer and a new buffer identifier is assigned whenever the buffer is reused.

With encrypted data in a memory, even with Electronic Code Book (ECB) encryption, the frequency distribution of the ciphertext may be measured. When the data contains many zero values, the frequency may reveal the plaintext more clearly. In a neural network or other ML system that processes through layers, activation data is the data that is passed from one layer of an ML system to another layer of the ML system. It contains many zero values in part due to the Rectified Linear Unit (ReLU) activation function, which is typically used in Neural Networks, and which maps all negative values to zero. The number of zeroes can be increased still further by an attacker that is able to provide the proper inputs. With ECB encryption, a block of ReLU activation data, or any other data, for which all values are zero always results in the same cipher text. Because of the high frequency of zero values, encrypted blocks that represent zero values have a high frequency as well. This allows an attacker to detect them. With some neural network and mathematical knowledge, an attacker will be able to use this information to reconstruct the model from ECB encrypted data.

For ML system layers, and for other types of multi-layer systems, the buffers of the inference engine are reused. The same memory space in the inference engine with the same buffer address is overwritten with new data from external memory. The memory space is reused to write different data in the case of layers of activation data in a machine learning model. The memory space is reused to write the same data in the case of weights buffers for each inference run. In other words, the machine learning model reads the same weights buffer data from external memory for use in every inference run.

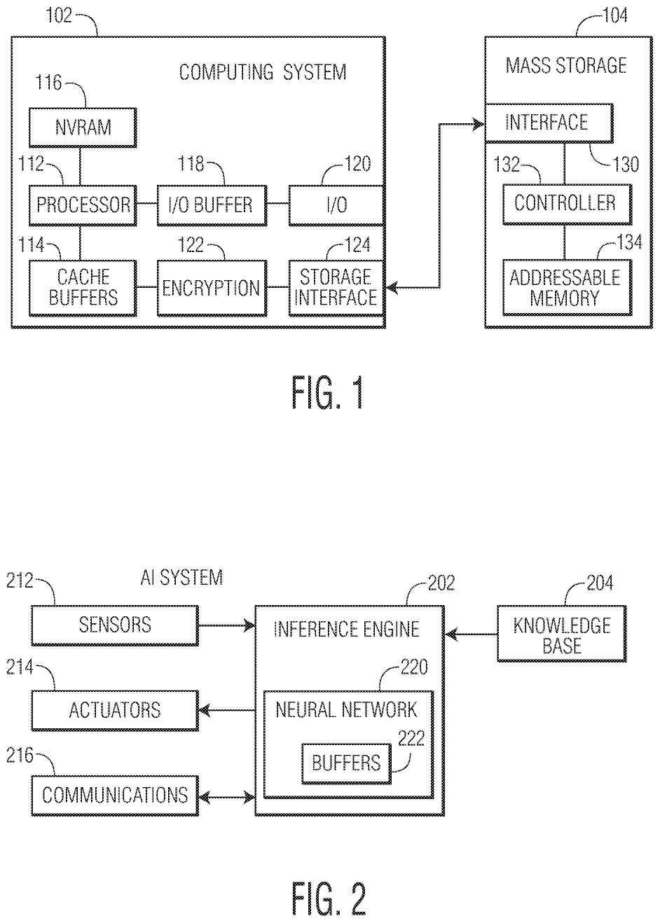

FIG. 1 is a block diagram of a device with a computing system 102 and encrypted mass storage 104. The computing system 102 includes a processor 112. Depending on its applications, the computing system 102 may include other components that may or may not be physically and electrically coupled to the processor 112. These other components include, but are not limited to cache buffers 114, which may be in the form of volatile memory (e.g., DRAM) or other fast memory for storing intermediate results and data read from the mass storage 104 for use in performing operations. The processor is further coupled to non-volatile memory, e.g., non-volatile random access memory (NVRAM) 116 or flash memory which may contain program instructions or other data suitable for slower access. The processor 112 is coupled to an input/output (I/O) buffer 118 which is coupled to an I/O port 120. The I/O port may be coupled to an antenna, a display, a touchscreen controller, a user interface device, and to other sensors e.g., a global positioning system (GPS) device, a compass, an accelerometer, a gyroscope, and other devices. The I/O port 120 may also be coupled to actuators, transmitters, communications interfaces, and other I/O devices.

The cache buffers 114 are coupled to an encryption engine 122, e.g., a crypto processor, which is coupled to a storage interface 124. The encryption engine has processing circuitry to encrypt and decrypt data using keys and tweaks. The processing circuitry may be in firmware, in dedicated hardware or in general purpose programmable hardware. The storage interface 124 is coupled to the mass storage 104 e.g., a hard disk drive, optical memory, flash memory, solid state memory storage, or other machine-readable memory. The mass storage includes an interface 130 coupled to the storage interface 124 of the computing system 102, a controller 132, e.g., a storage controller or memory controller, and addressable memory 134 that contains the registers for storing intermediate values, results, and reference values. The mass storage components may be connected to the computing system through a system board or cable interface, or may be combined with any of the other components. The interface between the storage interface 124 and the mass storage interface 130 may be wired or wireless and conform to any suitable packet communications protocol.

In embodiments, the computing system 102 reads data from the mass storage 104 into the cache buffers 114 for use in performing operations, e.g., artificial intelligence operations by the processor or other computing components of the device (not shown). The processor 112 reads from and writes to the cache buffers 114. The processor 112 writes new and modified values from the cache buffers 114 to the mass storage 104. The processor 112 tracks the memory addresses and generates buffer identifiers and passes these to an encryption engine 122. The encryption engine 122 receives data blocks in cipher text from the mass storage 104 and decrypts the data blocks from the mass storage 104 into plain text. The decrypted data blocks in plain text are written into the cache buffers 114. The encryption engine 122 receives data blocks from the cache buffers 114 and encrypts the data blocks before they are written to the mass storage 104. The data in the mass storage 104 is encrypted against an attacker with access to the mass storage or with access to the connection between the computing system 102 storage interface 124 and the mass storage 104 interface 120.

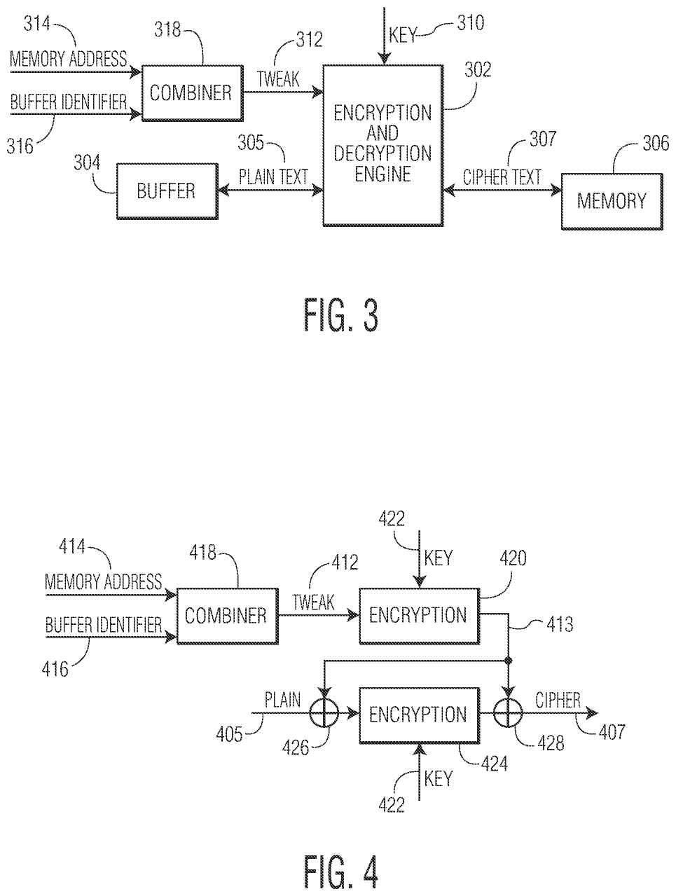

In some embodiments, the addressable memory 134 is divided into parts. For a disk drive, there is a convention of dividing the disk into sectors, that usually contain 512 bytes or 4096 bytes. The sectors are independently addressed and are encrypted and decrypted independently of each other. Sectors may be used for other types of addressable memory or other division schemes may be used in a similar way. When all of the sectors are encrypted in the same way, then an adversary is able to write encrypted data from one sector into another sector and then request its decryption. To prevent this and other attacks, the encryption may be modified for each sector. In order that no two sectors are encrypted in the same way, the encryption may be modified for each sector. In some embodiments, the modification is referred to as a tweak. A tweakable encryption method is modified each time the tweak is changed. This is described in more detail with respect to FIGS. 3 and 4.

FIG. 2 is a block diagram of an artificial intelligence system with an encrypted knowledge base. The system has an inference engine 202 coupled to a knowledge base 204, to sensors 212, to actuators 214 and to communications 216. The inference engine 202 includes a neural network 220 and buffers 222. Information is received from the sensors 212. For machine vision or image understanding, the sensors may be cameras. Other sensors may be used to suit different applications, including optical sensors, acoustic sensors, pressure sensors, thermal sensors, and range sensors, e.g., radar, lidar, or sonar. The information from the sensors 212 is received at and applied to the neural network 220 to draw inferences about the sensor data. The inferences are developed by writing appropriate portions of the knowledge base 204 to the buffers 222 of the neural network. The knowledge base 204 may be an external addressable memory with appropriate interfaces and encryption resources so that the information in the knowledge base is protected against any adversary.

The inferences from the inference engine 202 may be used to drive actuators 214 or to provide information to another external system (not shown) including the device of FIG. 1. For machine vision, the actuator 214 may be a robot arm in a manufacturing process or an inventory tracking system, or a selection system for quality assurance, although other actuators may be used instead. The communications 216 allows for a user interface and for inferences to be reported to an external system. The communications may also be used to update the knowledge base 204 as additional information is gathered.

In various implementations, the devices of FIGS. 1 and 2 may be a part of eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, wearables, or drones. The devices may be fixed, portable, or wearable. In further implementations, the devices may be any other electronic device that processes data. Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

In some embodiments herein, a tweakable block cipher is used in ECB mode to store the content of ML buffers in external memory. In some embodiments, the tweak includes at least two components. A first component is the memory address at which the encrypted block is stored in external memory. A second component is an identifier that represents a buffer in the external memory. The identifier is generated when the buffer is allocated, and a new identifier is generated for the same physical buffer every time the buffer is reused or re-allocated. If the buffer identifier is a 64-bit value, many re-allocations will occur before a buffer identifier is reused.

The two components, the memory address, and the buffer identifier, are combined to create a tweak that is used by a tweakable block cipher. This scheme results in a system for which the frequency distribution of the plaintext blocks is no longer reflected in the frequency distribution of the ciphertext blocks.

FIG. 3 is a block diagram of a data storage system using a tweakable encryption system. The data is securely stored in a memory 306. An encryption and decryption engine 302 encrypts and decrypts the stored data. As shown, cipher text 307 from the memory is decrypted in the encryption and decryption engine 302 to plain text 305 that is written into a buffer 304. Similarly plain text 305 from the buffer 304 is encrypted in the encryption and decryption engine 302 to be cipher text 307 that is written into the memory 306.

For encryption, the encryption and decryption engine 302 receives a data block from the buffer 304 as plain text and encrypts the data block. The encryption and decryption engine 302 uses a key 310, e.g., a secret encryption key, and a tweak 312 to perform the encryption. The key 310 may be the same for every encryption and decryption performed by the encryption and decryption engine 302, although this is not required. The combination of the tweak and the key, selects the permutation that is computed by the encryption and decryption engine 302. The encrypted cipher text data block is then written to the memory 306 at the location indicated by the memory address 314.

For decryption, the encryption and decryption engine 302 receives a data block from the memory 306, e.g., an external memory, as cipher text and decrypts the data block. The encryption and decryption engine 302 uses the key 310 and the tweak 312 to perform the decryption. The decrypted plain text block is then written to the buffer 304 identified by the buffer identifier 316. The encryption and decryption engine 302 includes processing circuitry to perform the encryption and decryption in response to executable instructions stored in a memory such as an NVRAM or the memory 306. The processing circuitry may also be configurable using a settable parameter in the form of an application specific integrated circuit (ASIC) or other device.

The tweak 312 takes different values for different data. As shown, a memory address 314 and a buffer identifier 316 are received as inputs to a combiner 318 that combines the two inputs to generate the tweak 312. In this way, the tweak will be different for each different memory address and for each buffer identifier. In some embodiments, the memory address 314 is the logical address of the memory 306 to which the data is written. A processor or memory manager provides the memory address 314 and the buffer identifier 316 to the combiner 318. In some embodiments, the memory 306 is divided into logical sectors and the memory address may include logical cylinder, head, and sector values. In some embodiments, the memory address may be a simple number referring to a logical block address. The actual logical address may be truncated, hashed, or otherwise shortened to simplify the operations to generate the tweak. The buffer identifier 316 identifies the buffer 304 or portion of a buffer that contains plain text 305 for use by the computing system. The identifier is assigned by the computing system as a temporary label to access the data in the buffer. The identifier does not directly identify a part of the addressable encrypted memory. Any of a variety of different identifiers may be used. For a machine learning (ML) system, identifiers are assigned to activation buffers and weights buffers by the inference engine, e.g., by a processor operating the inference engine or by a memory manager. These identifiers are provided to the combiner by the processor for use in generating the tweak. The identifier for these buffers changes for each layer of the ML system. In some embodiments, the buffer identifiers used by the ML system are used as the buffer identifier 316 input to the combiner 318.

A variety of encryption and decryption techniques may be used by the encryption and decryption engine 302. In embodiments, a tweakable block cipher is used for encryption and decryption. A block cipher encrypts each block of bits independently of each other block. Additional encryption may be added to the block cipher as an overlay or in sequence with the block cipher encryption. Randomization may be applied before or after the block cipher. There are a variety of different block ciphers that may be used for the encryption and decryption engine 302.

FIG. 4 is a block diagram of a tweakable block cipher using exclusive OR (XOR) operations, e.g., in an XOR-encrypt-XOR (XEX) construct. The XEX construct is one way to implement a tweakable block cipher but other ways may be used instead. A memory address 414 and a buffer identifier 416 are received as inputs at a combiner 418. The combiner 418 may perform any of a variety of different operations. In some embodiments, the combiner 418 concatenates the memory address 414 with the buffer identifier 416 to generate the tweak 412. In other words, a binary representation of the memory address is concatenated with a binary representation of the buffer identifier. In some embodiments an exclusive OR (XOR) or other logical operation is applied to the memory address and the buffer identifier.

The combiner 418 generates the tweak 412 which is provided to a first encryption block 420. The first encryption block also receives a key 422 and encrypts the tweak 412 with the key 422. The encrypted tweak 413 is provided at the input and output of a second encryption block 424. The plain text 405, e.g., from a processor or buffer, is received at a first exclusive OR (XOR) operator and an XOR operation is performed on the plain text 405 using the encrypted tweak 426. The result is encrypted by the second encryption block 424 which encrypts the result using the same key as the first encryption block or a different key. The second encryption block output is applied to the output XOR 428 which performs an XOR operation on the output also using the encrypted tweak 413 to generate cipher text 407. The cipher text 407 is written to a memory (not shown). The operations may be reversed to decrypt data read from the memory that is to be written to a cache or buffer (not shown) for use in one or more processes, e.g., ML or AI processes.

Embodiments are described in the context of protecting machine learning (ML) models from being stolen on devices in which the ML models are stored in an external memory and are used for inference, as with artificial neural networks. System security may be further enhanced by protecting the ML models against logical attacks, e.g., exploitation of software vulnerabilities, and by encrypting the external memory against probing the external memory interface bus.

In embodiments, the external memory is ECB mode encrypted with a symmetric block cipher so an attacker cannot steal the model through the external memory interface bus. Other modes of operation may be used instead of ECB encryption. Although ReLU activation functions are particularly vulnerable to some attacks, structures and techniques may be applied to other data and other activation functions. The structures and techniques may be applied to uses other than neural networks and ML.

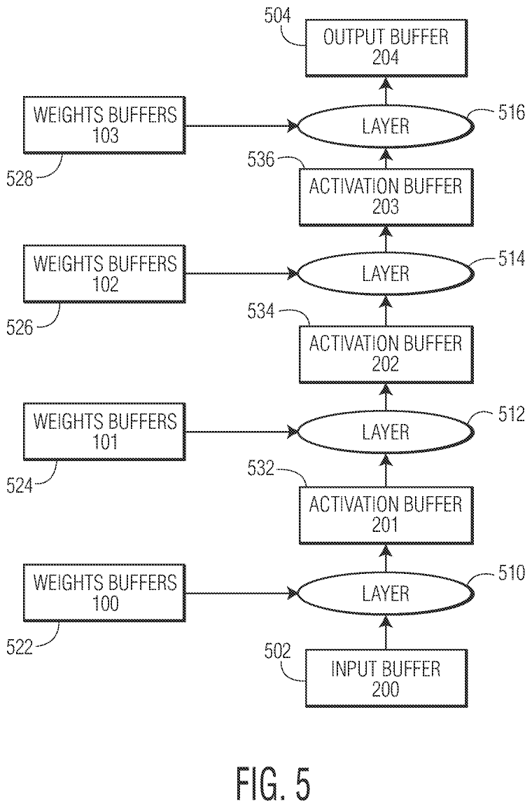

FIG. 5 is a diagram of an inference run through a machine learning system with activation buffers and weights buffers. The rectangles correspond to memory buffers. Each layer writes its produced data to a different memory buffer. Neural networks pass activation data from one layer to a successor layer via activation buffers. As shown, there are four layers 510, 512, 514, 516 in this inference run. There is an activation buffer 532, 534, 536 between each layer. The activation buffers 532, 534, 536 are buffers in memory through which the activation data is communicated from one layer to the next layer. Each layer accesses weights from a weights buffer 522, 524, 526, 528 to generate the corresponding activation data. Input data is stored in the input buffer 502 and applied to the first layer 510 and activation data is generated using weights from the first weights buffer 522 and passed to the first activation buffer 532. The activation data of the first activation buffer is passed to the second layer 512 which generates revised activation data using weights from the second weights buffer 524 and stores it in the second activation buffer 534. The second activation buffer is coupled to the third layer 514 which processes the revised activation data using weights from the third weights buffer 526 to generate further revised activation data which is stored in the third activation buffer 536. This is processed at the fourth layer 516 using weights from the fourth weights buffer 528 to generate the output data stored at the output buffer 504 for the first inference run.

The activation data sufficient for a layer typically requires a large buffer and so the buffers are maintained in memories that are external to the neural network or AI chip. This allows the processing section of the neural network to be fabricated in a process that is optimized for fast processing and the activation buffer section of the neural network to be fabricated in a process that allows for lower cost. Such a structure is shown in FIGS. 1 and 2. The on-chip memory is then used primarily for instructions and parameters that are required to be accessed with very high speed.

In some embodiments, the activation data is encrypted on-chip using ECB encryption with a tweakable block cipher to store all of the ML-related data, e.g., model weights and activation data, in external memory. Every time a layer 510, 512, 514, 516 is executed, a new identifier is assigned to the corresponding weights buffer used by the layer and to the activation buffer to which the layer will write its produced data. 100 is shown as an example buffer identifier for the first weights buffer 522, 101 for the second weights buffer 524, 102 for the third weights buffer 526, and 103 for the fourth weights buffer 528. Similarly, example identifiers are shown as 200 for the input buffer 502, 201 for the first activation buffer 532, 202 for the second activation buffer 534, 203 for the third activation buffer 536 and 204 for the output buffer. The identifiers may be shorter or longer to suit different applications and different structures may be used to suit each buffer.

When a layer accesses a memory buffer at a certain memory address in external memory, either by reading from the buffer or writing to the buffer, the layer provides the associated buffer identifier, e.g., 100, 101, 102, 103 for the weights buffers and 200, 201, 202, 203, 204 for the input, activation, and output buffers. The memory address and the buffer identifier are combined and are used as a tweak for the tweakable block cipher encryption when writing data, and for decryption when reading data. By tweaking the encryption of the data in external memory by both the memory address and a buffer identifier that is assigned when the buffer is used for the first time and then changed each time that the buffer is reused, the distribution of plaintext blocks is not reflected in the distribution of the ciphertext blocks.

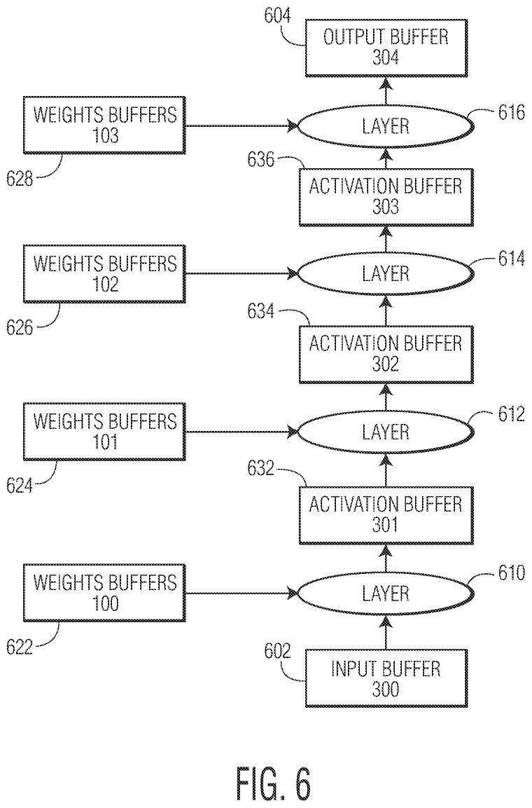

FIG. 6 is a diagram of a second inference run through the machine learning system with activation buffers and weights buffers. As in the first inference run, the rectangles correspond to memory buffers. Each layer writes its produced data to one memory buffer. Neural networks pass activation data from one layer to a successor layer via activation buffers. The assigned activation buffer identifiers in the second inference run are different from the assigned activation buffer identifiers in the first inference run of the neural network. Each activation buffer is assigned a unique buffer identifier for this subsequent inference run. In some embodiments, when the activation buffers are reused for different activation data, a new buffer identifier is generated and assigned to distinguish the difference in the activation data. The weights buffers are the same, with the same data and may also have the same logical address. The same weights buffer identifier may be used as for the first inference run.

As shown, there are also four layers 610, 612, 614, 616 in the second inference run. Although more or fewer may be used. There is an activation buffer 632, 634, 636 between and coupled to each respective layer. Each layer accesses weights from a weights buffer 622, 624, 626, 628 to generate the corresponding activation data. Input data from the input buffer 602 is applied to the first layer 610 and activation data is generated using weights from the first weights buffer 622 and passed to the first activation buffer 632. Each layer generates activation data for the corresponding activation buffer through to the output buffer 604 as in the first inference run.

The buffer identifiers 100, 101, 102, 103 for the weights buffers 622, 624, 626, 628 are the same and the weights buffers may contain the same data as for the first inference run. The buffer identifiers 300, 301, 302, 303, 304 for the input buffer 602, activation buffers 632, 634, 636, and the output buffer 604 for the second inference run are different than for the first inference run. When a layer accesses a memory buffer at a certain memory address in external memory, either by reading from the buffer or writing to the buffer, the layer provides a different associated buffer identifier than for the first inference run. When the memory address and the buffer identifier are combined, then a different tweak is provided for the tweakable block cipher encryption which then provides a different encryption and decryption result.

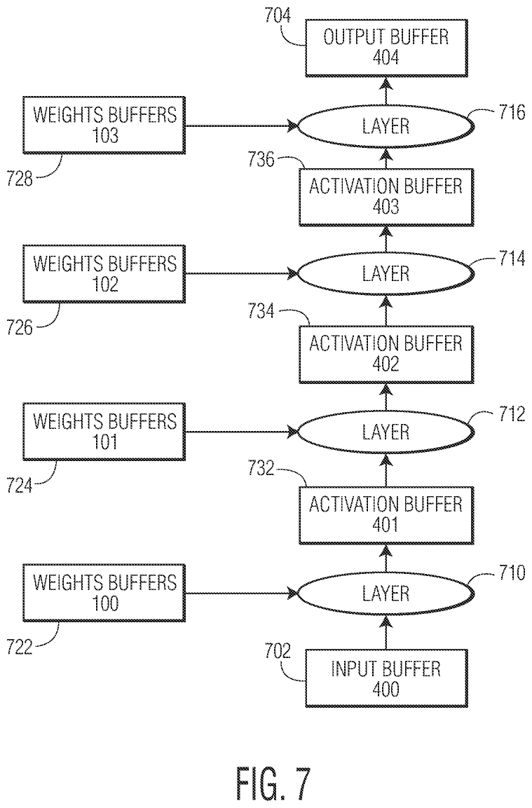

FIG. 7 is a diagram of a third inference run through the machine learning system with activation buffers and weights buffers. As in the first inference run, the rectangles correspond to memory buffers. In the third inference run, the weights buffers 722, 724, 726, 728 have the same buffer identifiers 100, 101, 102, 103. As in the previous inference run, each activation buffer 732, 734, 736 is assigned a unique buffer identifier for this subsequent inference run. The newly re-assigned buffer identifiers for the activation buffers are 401, 402, 403. The input buffer 702 is assigned identifier 400 and the output buffer 704 is assigned buffer identifier 404. When the buffer identifier is used as a part of the tweak in encrypting the buffer contents, the cipher text will be different in each inference run.

As in the previous inference runs, an input buffer 702 is coupled to and provides input data to a first layer 710 of this first run. There are four layers 710, 712, 714, 716 with an activation buffer 732, 734, 736 between and coupled to each respective layer. Each layer accesses weights from a respective weights buffer 722, 724, 726, 728 to generate the corresponding activation data. Each layer generates activation data for the corresponding activation buffer through to the output buffer 704 as in the first inference run.

The buffer identifiers 100, 101, 102, 103 for the weights buffers 622, 624, 626, 628 are the same and the weights buffers may contain the same data as for the first inference run. The buffer identifiers 300, 301, 302, 303, 304 for the input buffer 602, activation buffers 632, 634, 636, and the output buffer 604 for the second inference run are different than for the first inference run. When a layer accesses a memory buffer at a certain memory address in external memory, either by reading from the buffer or writing to the buffer, the layer provides a different associated buffer identifier than for the first inference run. When the memory address and the buffer identifier are combined, then a different tweak is provided for the tweakable block cipher encryption which then provides a different encryption and decryption result

The frequency distribution of the model may be changed each time the model is encrypted by changing the tweak. In embodiments, the memory address is the same but the buffer identifier is different each time the model is encrypted to be stored in the memory. For a neural network with multiple layers, this happens each time the model is applied to a new layer. Such a buffer identifier may be supplied by the neural network software or in another way. The buffer is then reused or re-allocated and a new buffer identifier is generated and then used to distinguish the use of the buffer at each layer. In some embodiments, the buffer identifier for neural networks is fixed for each activation buffer. An inference counter may be maintained for each activation buffer. The inference counter is incremented on every run of the neural network. The buffer identifier is then the concatenation of the fixed activation buffer identifier and the current increment of the inference counter.

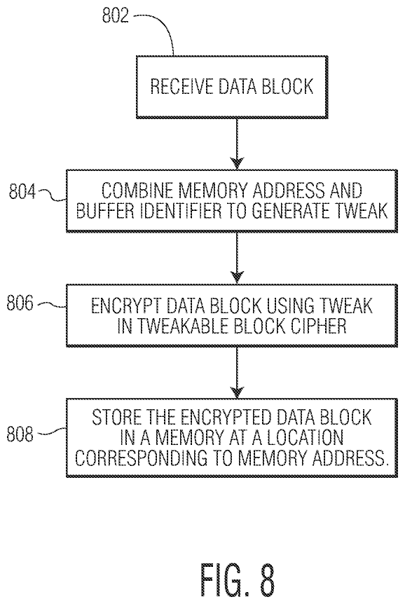

FIG. 8 is a process flow diagram of using a buffer identifier and a memory address together as tweak for memory encryption. At 802, an encryption engine receives a data block. The data block that is to be encrypted may be from a buffer that has a buffer identifier associated with it and may be in the form of plain text or cipher text in an intermediate form.

At 804, the encryption engine combines a memory address and a buffer identifier to generate a tweak. The memory address may be an address to an addressable memory that the block will be written to after encryption. A computing system that may include the encryption engine and the buffer may allocate the buffer to the data block and then generate the buffer identifier when the buffer is allocated to the data block. For some operations the buffer may then be re-allocated to the data block and a new buffer identifier is generated when the buffer is re-allocated. The new buffer identifier is generated notwithstanding the memory address at which the encrypted data block will be stored.

In some embodiments, the data block is comprised of activation data of a machine learning inference model. For some models, the activation data is configured for a rectified linear unit activation function. The data block may part of activation data and the buffer may be an activation buffer, where the activation data is passed from one layer of a machine learning system to another layer of the machine learning system through the activation buffer. A new buffer identifier may be generated for each inference run of the machine learning system. The new buffer identifier may be generated using an increment counter. In some embodiments a fixed buffer identifier is combined with a current increment of the inference counter that increments for each inference run of the machine learning system. The buffer identifier may take any suitable form and in some embodiments is a 64-bit binary value.

The memory address and buffer identifier may be combined by concatenating a binary representation of the memory address with a binary representation of the buffer identifier. The memory address may be modified by various operations before being combined including truncation, XOR, encrypted and other operations. As an example, the memory address and buffer identifier may be combined by applying an exclusive OR operation to the memory address and the buffer identifier.

When a new buffer identifier is generated, then the encryption engine combines the memory address and the new buffer identifier to generate a new tweak. The data block is encrypted using the new tweak in a tweakable block cipher. In this way even if the memory address is the same, the frequency distribution of the encrypted data block with the first tweak is different from the frequency distribution of the encrypted data block with the new tweak.

At 806, the data block is encrypted using the tweak in a tweakable block cipher. In some embodiments, the tweakable block cipher is in an electronic code book (ECB) mode. In some embodiment the tweakable block cipher is a symmetric block cipher.

At 808, the encrypted data block is stored in a memory at a location corresponding to the memory address. In embodiments, the memory is an external memory to the encryption engine and the encryption engine is coupled the external memory through a storage interface.

As described herein the buffer identifier is used to tweak the block cipher so that the frequency distribution of the ciphertext no longer depends upon the distribution of the plaintext. A new buffer identifier may be assigned to a buffer whenever the buffer is reused.

In the following description and claims, the term “coupled” along with its derivatives, may be used. “Coupled” is used to indicate that two or more elements have a connection that permits interaction but that there may be intervening physical or electrical components between them.

As used in the claims, unless otherwise specified, the use of the ordinal adjectives “first,” “second,” “third,” etc., to describe a common element, merely indicate that different instances of like elements are being referred to, and are not intended to imply that the elements so described must be in a given sequence, either temporally, spatially, in ranking, or in any other manner.

Orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. Certain operations may be performed, at least in part, concurrently with other operations. In another embodiment, instructions or sub-operations of distinct operations may be implemented in an intermittent and/or alternating manner. The scope of embodiments is by no means limited by these specific examples. Numerous variations, whether explicitly given in the specification or not, e.g., differences in structure, dimension, and use of material, are possible. The scope of embodiments is at least as broad as given by the following claims.

It should also be noted that at least some of the operations for the methods described herein may be implemented using software instructions stored on a machine-readable storage medium or memory for execution by a machine, e.g., a computer or processing circuitry. As an example, an embodiment of a computer program product includes a machine-readable storage medium to store a machine-readable program.

The computer-useable or machine-readable storage medium can be an electronic, magnetic, optical, electromagnetic, infrared, or semiconductor system (or apparatus or device). Examples of non-transitory computer-useable and machine-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

What is claimed is:

1. A method comprising:
receiving a data block from a buffer, the buffer having a buffer identifier;
combining a memory address and the buffer identifier to generate a tweak;
encrypting the data block using the tweak in a tweakable block cipher; and
storing the encrypted data block in a memory at a location corresponding to the memory address.

2. The method of claim 1, wherein encrypting the data block comprises using a tweakable block cipher in electronic code book mode.

3. The method of claim 1, wherein encrypting the data block comprises encrypting using a symmetric block cipher.

4. The method of claim 1, further comprising:
allocating the buffer to the data block; and
generating the buffer identifier when the buffer is allocated to the data block.

5. The method of claim 4, further comprising:
re-allocating the buffer to the data block; and
generating a new buffer identifier when the buffer is re-allocated.

6. The method of claim 5, wherein generating a new buffer identifier comprises generating a new buffer identifier notwithstanding the memory address.

7. The method of claim 5, further comprising:
combining the memory address and the new buffer identifier to generate a new tweak; and
encrypting the data block using the new tweak in a tweakable block cipher, wherein the frequency distribution of the encrypted data block with the first tweak is different from the frequency distribution of the encrypted data block with the new tweak.

8. The method of claim 1, wherein the buffer identifier is a 64-bit value.

9. The method of claim 1, wherein the data block is comprised of activation data of a machine learning inference model.

10. The method of claim 1, wherein the data block is part of activation data and the buffer is an activation buffer and wherein the activation data is passed from one layer of a machine learning system to another layer of the machine learning system through the activation buffer.

11. The method of claim 10, further comprising generating a new buffer identifier for each inference run of the machine learning system.

12. The method of claim 11, wherein generating a new buffer identifier comprises combining a fixed buffer identifier with a current increment of an inference counter that increments for each inference run of the machine learning system.

13. The method of claim 10, wherein the activation data is configured for a rectified linear unit activation function.

14. The method of claim 1, wherein the memory is an external memory.

15. The method of claim 1, wherein combining comprises concatenating a binary representation of the memory address with a binary representation of the buffer identifier.

16. The method of claim 1, wherein combining comprises applying an exclusive OR operation to the memory address and the buffer identifier.

17. A tweakable block cipher comprising a memory storing executable instructions configured to, when executed by processing circuitry of the tweakable block cipher, cause the processing circuitry to perform operations comprising:
receiving a data block from a buffer, the buffer having a buffer identifier;
combining a memory address and the buffer identifier to generate a tweak;
encrypting the data block using the tweak in a tweakable block cipher; and
storing the encrypted data block in a memory at a location corresponding to the memory address.

18. The tweakable block cipher of claim 17, wherein combining comprises concatenating a binary representation of the memory address with a binary representation of the buffer identifier.

19. A machine learning system comprising:
an addressable memory;
a buffer, the buffer having a buffer identifier;
a tweakable block cipher to receive a data block from the buffer, to combine a memory address to the addressable memory and the buffer identifier of the buffer to generate a tweak, and to encrypt the data block using the tweak; and
a storage interface to store the encrypted data block in the addressable memory at a location corresponding to the memory address.

20. The machine learning system of claim 19 further comprising a processor to execute layers of a neural network, the processor further allocating the buffer to the data block, generating the buffer identifier when the buffer is allocated to the data block, and providing the buffer identifier to the tweakable block cipher.
